(19) United States
(12) Patent Application Publication
(10) Pub. No.: US 2007/0165189 A1
(43) Pub. Date: Jul. 19, 2007

(54) Projection type image display apparatus

(76) Inventors: Junko Kawase, Tokyo (JP); Masahiko Yatsu, Fujisawa (JP); Fukuyasu Abe, Yokohama (JP); Seiji Murata, Yokohama (JP); Satoshi Ouchi, Kamakura (JP); Toshiyasu Sawano, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/513,368

(22) Filed: Aug. 31, 2006

(30) Foreign Application Priority Data
Jan. 18, 2006 (JP) 2006-009388
Jan. 20, 2006 (JP) 2006-011838

(51) Int. Cl. G03B 21/00

(52) U.S. Cl. 353/31

(57) ABSTRACT

A projection type image display apparatus able to improve the utilization efficiency of light and attain a high luminance of light. An optical waveguide for guiding light emitted from a light source is provided, and a color separator for transmitting predetermined color light included in the light guided by the optical waveguide and for reflecting predetermined color light included in the guided light is also provided. The light reflected by the color separator is guided by the optical waveguide and is thereafter reflected by a reflecting member. The light reflected by the reflecting member is radiated into the optical waveguide and conducted thereby to the color separator.

### CLAIM OF PRIORITY

The present application claims priority from Japanese applications JP 2006-009388 filed on Jan. 18, 2005 and JP 2006-011838 filed on January 20, the content of which is hereby incorporated by reference into this application.

### BACKGROUND OF THE INVENTION

1. Field of the Invention

The present invention relates to an optical unit-incorporating projection type image display apparatus for projecting an image onto a screen in which an image display element is used, such as a transmission type image display projector, a reflection type image display projector, or a projection type rear projection television.

2. Description of the Related Art

Conventionally, a single plate projection type image display apparatus has been known in which light emitted from a light source is passed, for example, through a first and second array lenses, a polarization beam splitter (PBS) and a collimator lens, then is separated into R light, B light, and G light, which are then radiated respectively onto different regions on a single image display element using a color wheel, the irradiation regions of R light, B light and G light being scrolled successively in a fixed direction over the image display element.

Generally, in the conventional single plate projection type image display apparatus, a rod integrator, which is small in the number of parts and simple in structure, is used as an integrator optical system for uniforming light emitted from a light source. In the case of a liquid crystal panel in which an image display element performs light intensity modulation by using a polarizing action, a polarization converter is combined with the rod integrator.

Since the single plate projection type image display apparatus is low in its light utilization efficiency, studies are being made about a color recapture method in which reflected light is reused when performing color separation. For example, JP-A-2003-270586 has disclosed a construction in which a reflective end face used for recapture is provided at a specific position between an aperture on an incidence side and an exit side of the integrator in order to suppress a loss caused by reflection on an inner wall of an integrator.

Further, in JP-A-2003-098483 has disclosed a construction in which a rod type optical element, a reflection type polarization separator and a quarter-wave plate are used. In this construction, light reflected by the reflection type polarization separator is further reflected by a reflective surface provided in an incidence plane of the rod type optical element to effect polarization conversion in order to improve the utilization efficiency of light, then the light after the polarization conversion is time-shared by a rotary color filter.

### SUMMARY OF THE INVENTION

In JP-A-2003-270586, the utilization efficiency of light is improved at the reflective end face provided at an intermediate position of the integrator, but no consideration is given to polarization conversion in case of using a liquid crystal display element as an image display element.

JP-A-2003-098483 has disclosed a construction in which the light reflected by the reflection type polarization separator is again used for polarization conversion using a quarter-wave plate. However, no consideration is given to reuse of the light reflected by the rotary color filter.

It is an object of the present invention to improve the utilization efficiency of light and attain a high luminance of image.

In order to achieve the above-mentioned object, a projection type image display apparatus according to one aspect of the present invention provides a light reuse mechanism which guides light emitted from a light source and reflected by a polarization converter/separator or a color separator to a liquid crystal display element.

### BRIEF DESCRIPTION OF THE DRAWINGS

FIG. 1A is a side view of a projection type image display apparatus according to a first embodiment of the present invention;

FIG. 1B is a top view thereof;

FIG. 2A is a side view of a projection type image display apparatus according to a second embodiment of the present invention;

FIG. 2B is a top view thereof;

FIG. 3A is a side view of a projection type image display apparatus according to a third embodiment of the present invention;

FIG. 3B is a top view thereof;

FIG. 4A is a side view of a projection type image display apparatus according to a fourth embodiment of the present invention;

FIG. 4B is a top view thereof;

FIG. 5A is a side view of a projection type image display apparatus according to a fifth embodiment of the present invention;

FIG. 5B is a top view thereof;

FIG. 5C is a front view thereof;

FIG. 6 is a side view of a projection type image display apparatus according to a sixth embodiment of the present invention;

FIG. 7A is a side view of a projection type image display apparatus according to a seventh embodiment of the present invention;

FIG. 7B is a top view thereof;

FIG. 7C is an enlarged view thereof;

FIG. 8 is a general view of a projection type image display apparatus;

FIG. 9 is a top view of a projection type image display apparatus according to an eighth embodiment of the present invention;

FIG. 10 is a construction diagram of a principal portion, showing an example of a polarization converter/color separator unit;

FIG. 11 illustrates a construction example of a color wheel;

FIG. 12 is a light ray diagram illustrating a re-circulation process of a light beam reflected by the color wheel;

FIG. 13 is a construction diagram of a polarization converter/color separator unit using another rod integrator;

FIG. 14 is a construction diagram of a polarization converter/color separator unit using a still another rod integrator;

FIG. 15 is a construction diagram of a principal portion of a polarization converter/color separator unit in a projection type image display apparatus according to a ninth embodiment of the present invention;

FIG. 16 is a construction diagram of a principal portion of a polarization converter/color separator unit in a projection type image display apparatus according to a tenth embodiment of the present invention;

FIG. 17 illustrates another example of a color wheel; and

FIG. 18 illustrates a further example of a color wheel.

### DETAILED DESCRIPTION OF THE PREFERRED EMBODIMENTS

Plural embodiments of the present invention will be described hereinunder with reference to the accompanying drawings.

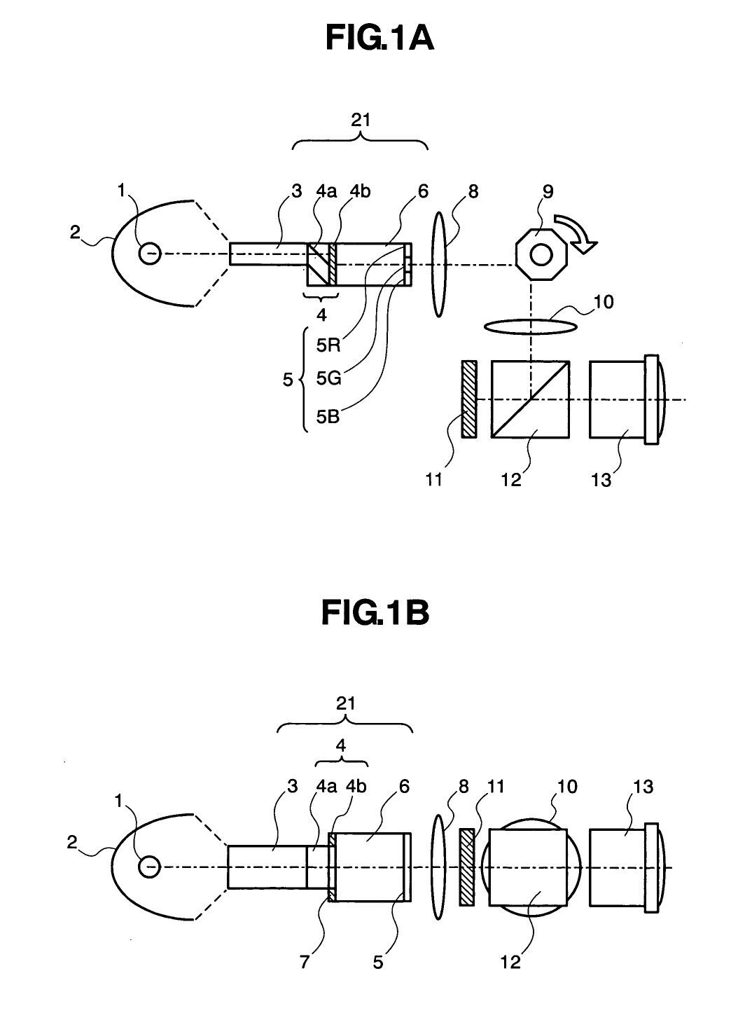

FIG. 1 illustrates an optical unit in a projection type image display apparatus according to a first embodiment of the present invention. FIG. 1A is a side view showing a schematic construction of the optical unit and FIG. 1B is a top view of the optical unit. The image display apparatus comprises the optical unit shown in FIG. 1, a power supply for supplying predetermined electric power to a light source, and a video signal processing unit for the supply of a video signal to an image display element in the optical unit.

In an optical unit used in a projection apparatus such as a liquid crystal projector, a reflection type image display projector, and a projection type rear projection television, as a light source 1, a xenon lamp, a metal halide lamp, a ultra-high pressure mercury vapor lamp, or a high output lamp is adopted in order to ensure a required brightness of a projected image. Instead of the lamps described above, a light source such as a LED, any of various color laser light sources, or an electrode-free lamp may be used. A reflector 2, which is mounted around the light source 1, has an internal mirror surface formed as a rotary elliptic surface, a secondary curved surface, or a free curved surface. The reflector 2 reflects and condenses light emitted from the light source 1 (see a broken line in the figure) and then radiates the light into an incidence aperture of an optical waveguide 3. The optical waveguide 3 is formed, for example, by a light pipe or rod lens made of glass or a plastic material or by a light funnel which is a reflecting mirror. The light emitted from the light source 1 is reflected in the interior of an integrator 21, whereby the distribution of illuminance becomes uniform.

The integrator includes the optical waveguide 3, a polarization converter 4, and an optical waveguide 6. As noted above, the light emitted from the light source 1 and condensed through the reflector 2 first passes through the optical waveguide 3 to uniform the distribution of illuminance and then enters an incidence aperture of the polarization converter 4. The polarization converter 4 comprises a combination of a polarization beam splitter 4a and a half-wave plate 4b to regulate randomly polarized light into s- or p-polarized light.

The light emitted from the polarization converter 4 enters a color separator 5 for separating white light into plural color light beams and is thereby separated into three colors R, G, and B. For example, the color filter 5 is constituted by a laminate of plural (three in this embodiment) transmission filters (color filters), each color filter comprises a R color filter 5R to transmit R light, a G color filter 5G to transmit G light, and a B color filter 5B to transmit B light. Thus, the emitted white light is output in a divided form into R light, G light, and B light. The R color filter 5R which transmits R light reflects both G light and B light. The G color filter 5G which transmits G light reflects both R light and B light. The B color filter 5B which transmits B light reflects both R light and G light. With this configuration, R light, G light and B light exit from the optical waveguide 6 and are separated and reflected by the color filters 5R, 5G, and 5B.

The color filters 5R, 5G, and 5B may be substituted by, for example, plural dichroic mirrors or dichroic prisms. The three-color separation of R, G, and B may be substituted by such a multi-color separation as four colors R, G, B, and Y, or six colors R, G, B, Y, M, and Cy. There also may be adopted a construction wherein the order of R, G, and B is changed for example into the order of R, G, R, B, to further improve the uniformity.

The optical unit described above is provided with a polygon mirror 9 as color light moving means for radiating at least one or plural color light beams to a predetermined region of the image display element with respect to the plural color light beams outputted from the color separator 5 and is also provided with third lighting means 8 for conducting the plural color light beams outputted from the color separator to the color light moving means. Preferably, the optical unit is constructed so that at least one or plural color light beams are incident nearly perpendicularly on one surface of the polygon mirror 9, and the color light beams radiated onto the image display element be scanned uniformly. The polygon mirror 9 as color light moving means may be substituted by an electronic color switching element or a color wheel.

FIG. 1B is a top view showing a schematic construction of the optical unit serving as a principal constituent portion. In addition to the foregoing separated light beams into R, G, and B, there are light beams not passed through but reflected by the color filters. The light reflected from the color filter 5R passes through the interior of the optical waveguide 6 and is reflected by a reflecting mirror 7, then is again incident on the color filter. The optical waveguide 6 is formed, for example, by a light pipe or rod lens made of glass or a plastic material or by a light funnel which is a reflecting mirror. An optical waveguide formed using different material and construction from those of the optical waveguide 3 is also employable as the optical waveguide 6. The reflecting mirror 7 is formed inside the outer periphery of an incidence surface-side aperture of the optical waveguide 6.

In the case where the polarization converter 4 is disposed between the light source 1 and the optical waveguide 3, the service life of the polarization beam splitter 4a which is partially formed of an organic material is shortened by the light source 1 which is high in temperature. Moreover, as the uniformly polarized light is reflected repeatedly by recapture, the polarization becomes disordered and the utilization efficiency of light in the liquid crystal display element is rather deteriorated. On the other hand, in the case where the polarization converter 4 is disposed between the optical waveguide 6 and the color filter 5, the light passes a plural number of times through the polarization beam splitter 4a due to reflection, so that the absorption of light by the polarization beam splitter 4a increases, resulting in that the utilization efficiency of light is deteriorated. Therefore, according to the construction of the optical unit used in this embodiment, the polarization converter 4 is disposed between the optical waveguides 3 and 6. Alternatively, the polarization converter 4 is disposed ahead of the reflecting mirror 7 used in recapture. According to this construction, the polarized light is not disordered and the absorption thereof in the polarization converter 4 can be suppressed, so that it becomes possible to improve the utilization efficiency of light which is recaptured.

That is, the randomly polarized light emitted from the light source 1 passes through the optical waveguide 3 and is uniformed into a predetermined polarized light by the polarization converter 4. Then, the polarized light passes through the optical waveguide 6 and is conducted to the color separator 5, in which it is separated into three-color light beams, i.e., R light, G light, and B light. Reflected light not separated by the color separator 5 is again conducted to the reflecting mirror 7 by the optical waveguide 6. After the reflection, the light enters the color separator 5 again, in which it is separated. According to this construction, the quantity of each color light outputted from the color separator 5 can be increased and it becomes possible to obtain a projected image superior in illuminance.

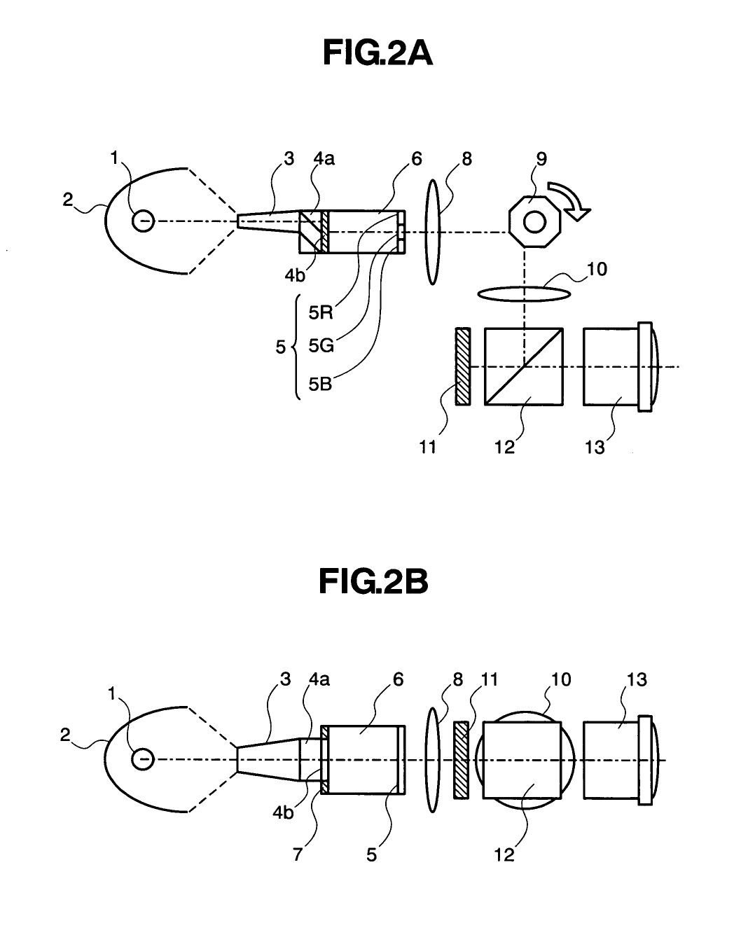

With reference to FIG. 2, an optical unit in a projection type image display apparatus according to a second embodiment of the present invention will be outlined below. FIG. 2A is a side view showing an outline of the optical unit. FIG. 2B is a top view thereof.

According to this second embodiment, in the basic structure shown in FIG. 1, the optical waveguide 3 for conducting the light condensed by the reflector 2 to the polarization converter 4 is formed in a shape having an incidence area and an exit area different from each other. For example, it is in a divergent tapered shape. By adopting such a divergent tapered shape of the optical waveguide 3 the reflection angle within the optical waveguide becomes gentle, making F value larger. It is preferable that the F value of light incident on the polarization converter be large. By making large the F value of output light from the optical waveguide 3, not only the lowering of the utilization efficiency of light related to an angle characteristic in the polarization converter 4 is suppressed, but also the polarization conversion efficiency is improved.

In FIG. 2B, the reflecting mirror 7 is provided at the inlet of the optical waveguide 6 and on both right and left sides of the incidence aperture. It is preferable that the reflecting mirrors 7 be positioned symmetrically right and left, but may be offset to one side (right or left).

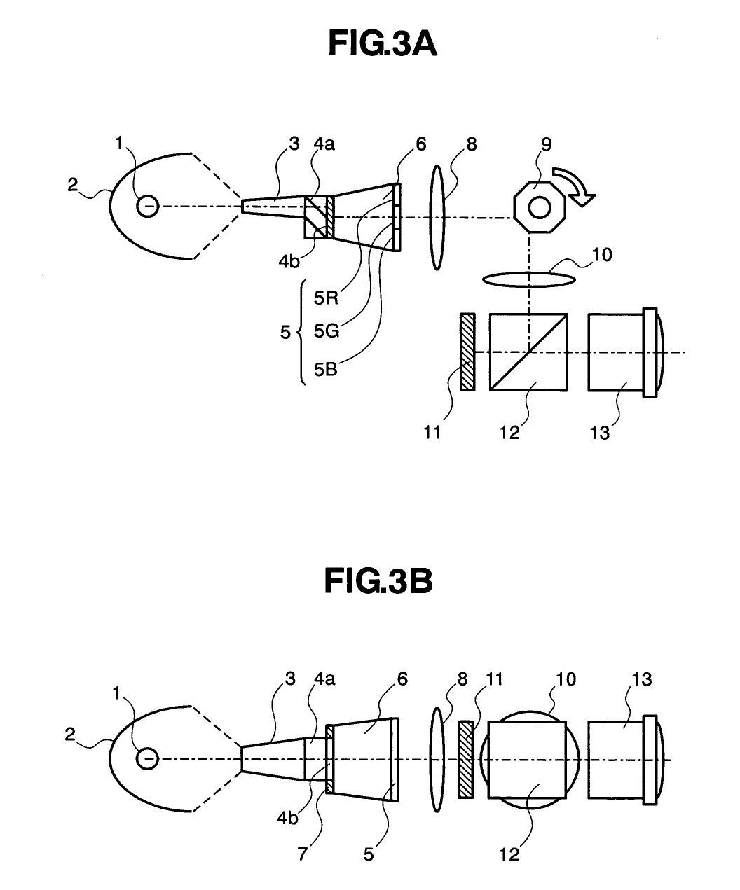

FIG. 3 shows an outline of an optical unit in a projection type image display apparatus according to a third embodiment of the present invention. FIG. 3A is a side view of the optical unit and FIG. 3B is a top view thereof.

According to this third embodiment, in the basic structure shown in FIG. 1, the optical waveguide 6 for conducting light from the polarization converter 4 to the color separator 5 is formed in a shape having an incidence area and an exit area different from each other. For example, it is formed in a divergent tapered shape. By forming the optical waveguide 6 in such a divergent tapered shape, the F value of output light is made large, the deterioration of contrast attributable to the angle dependence of the image display element is prevented and the contrast performance is improved. Further, the angle characteristic of transmission or reflection in the color separator 5 is improved, the lowering of the polarization conversion efficiency is suppressed and the contrast of an output image is improved.

According to the embodiment illustrated in FIG. 2 or FIG. 3, it can be said that if the area of the incidence plane in the integrator 21 is smaller than that of the exit plane in the integrator, the F value of output light from the integrator 21 can be made large and the contrast performance can be improved. Particularly, in the case of the embodiment illustrated in FIG. 2, the polarization efficiency of the polarization converter 4 can be improved because the F value of light incident on the polarization converter 4 becomes large. Further, in the case of the embodiment illustrated in FIG. 3, the influence of the angle dependence of the color separator 5 can be diminished since the F value of output light to the color separator 5 becomes large. Thus, the combination of the two embodiments is preferable.

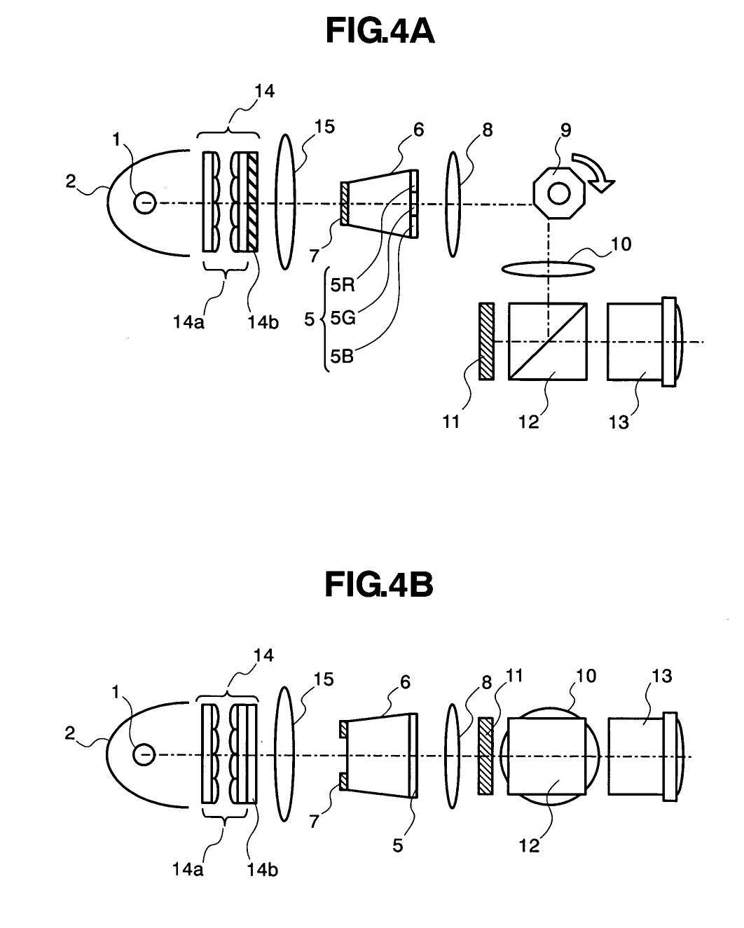

With reference to FIG. 4, an optical unit in a projection type image display apparatus according to a fourth embodiment of the present invention will be outlined below. FIG. 4A is a side view of the optical unit and FIG. 4B is a top view thereof.

According to this fourth embodiment, in the basic structure shown in FIG. 1, the optical unit includes, in the lighting system for conducting the light emitted from the light source 1 to the color separator 5, at least one or plural array lenses 14a, a polarization converter 14b, and a collimator lens 15 which superimposes images formed by the array lenses together at the same position. This fourth embodiment can provide a construction of re-utilizing color light so far unnecessary in an optical system using array lenses.

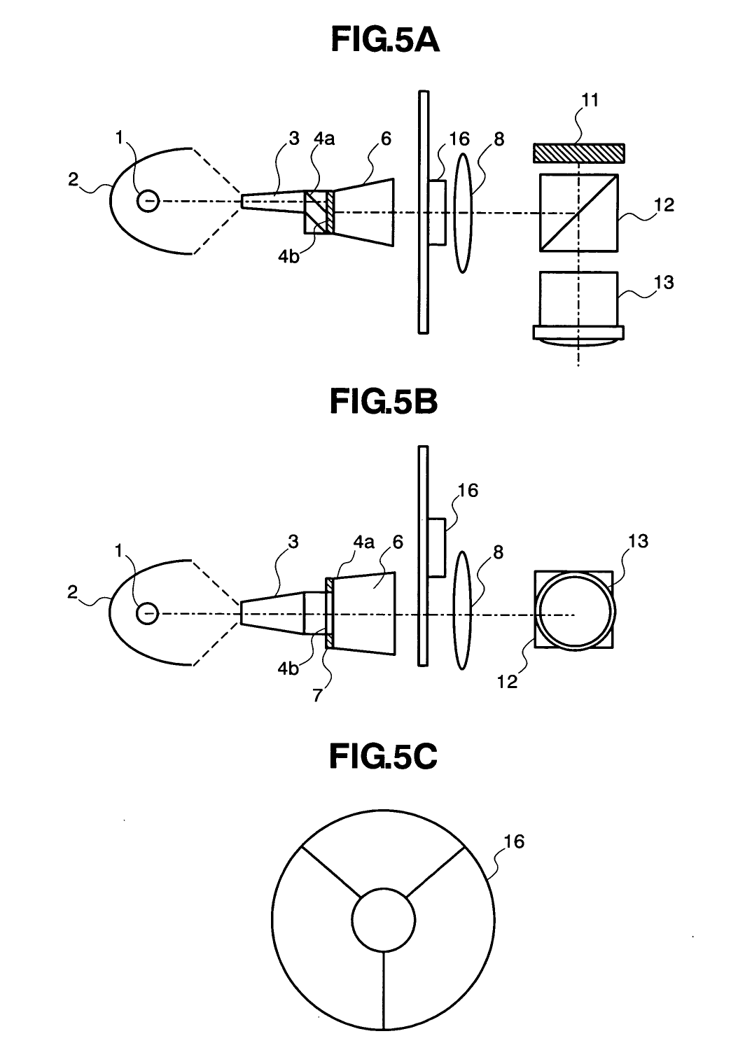

With reference to FIG. 5, an optical unit in a projection type image display apparatus according to a fifth embodiment of the present invention will be outlined below. FIG. 5A is a side view of the optical unit and the FIG. 5B is a front view thereof.

According to the construction of this fifth embodiment, in the basic structure shown in FIG. 1, the color filter 5 is substituted by a rotating body provided with plural color transmitting means and adapted to rotate successively in one direction, e.g., a color wheel 16, as color light moving means. Color light reflected by the color wheel, which color light has so far not been used, passes through the interior of the optical waveguide 6 while being reflected, is conducted to the reflecting surface 7 and is reflected thereby, then again enters the color wheel 16 and can be reused. Thus, it is possible to improve the efficiency. In FIG. 1A, it is possible to constitute an optical system in which the color light moving means and the color filter 5 are combined together. Consequently, it is possible to provide a simple optical system with a reduced number of parts.

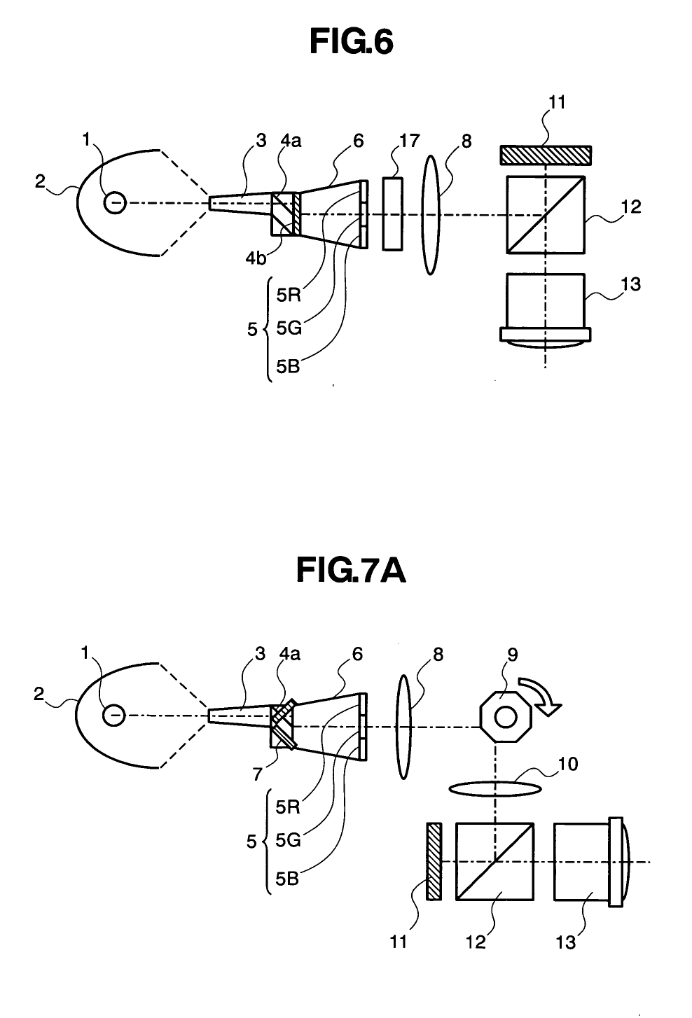

FIG. 6 shows an outline of an optical unit in a projection type image display apparatus according to a sixth embodiment of the present invention. According to this sixth embodiment, in the basic structure shown in FIG. 1, an optical element which causes an optical path of incident light to be changed by an inputted electric signal, e.g., a hologram optical element 17, can be utilized as color light moving means. By electrically driving the hologram element 17, it is possible to construct the optical unit so as to radiate color light to a predetermined region on the image display element. By changing the electric signal inputted to the hologram element with the lapse of time, it is possible to move color light with time. Thus, it becomes possible to build an optical system exclusive of a drive section.

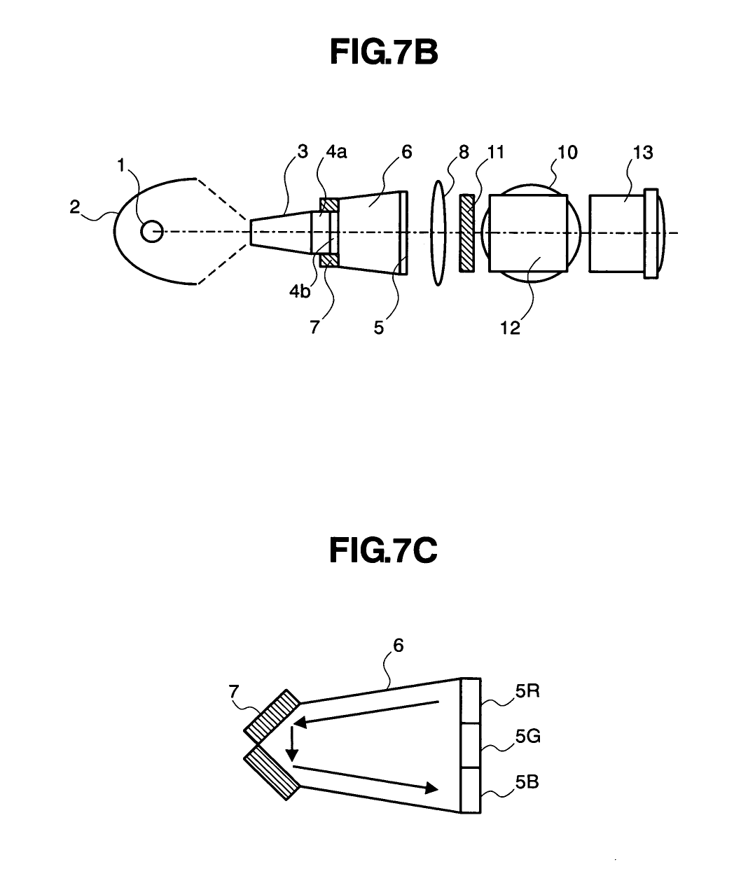

With reference to FIG. 7, an optical unit in a projection type image display apparatus according to a seventh embodiment of the present invention will be outlined below. FIG. 7A is a side view of the optical unit and FIG. 7B is a top view thereof. According to this seventh embodiment, in the basic structure shown in FIG. 1, the shape of the reflecting surface 7 for reflecting one or plural color light beams reflected from the color separator 5 is constituted by a surface having a predetermined angle.

FIG. 7C is an enlarged constructional diagram of an optical waveguide 6, reflecting surfaces 7, and a color separator 5. The arrows in the figure indicate a schematic optical path of color light reflected by the color separator 5R and so far not used. The color light reflected by the color separator 5R and so far not used passes through the interior of the optical waveguide 6 and is conducted to the reflecting surfaces 7 formed at a predetermined angle, then is again incident on the other color separators 5G and 5B other than 5R. Thus, the utilization efficiency is improved. At this time, the re-utilized light is incident mainly on 5G and 5B in a state of being superior in uniformity or light distribution as compared with the case of a plane reflecting mirror.

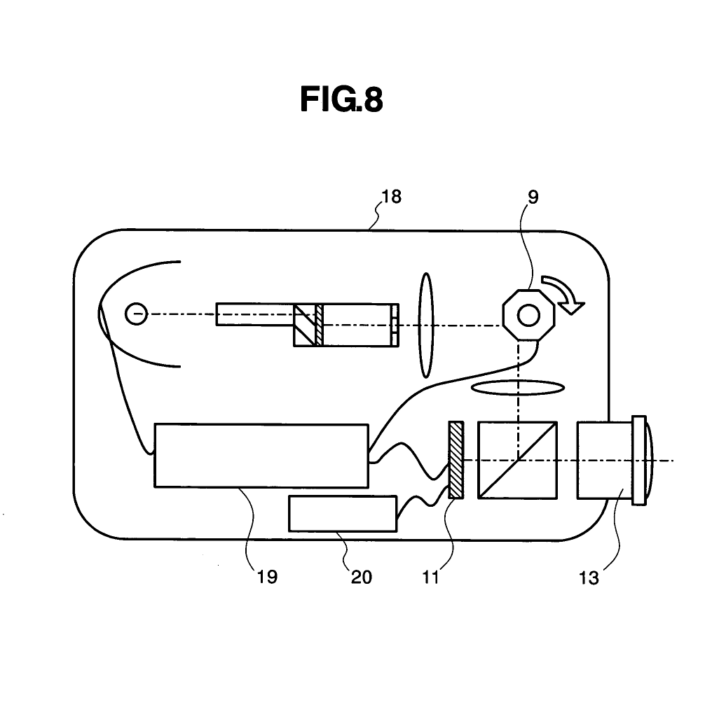

FIG. 8 shows an internal construction of an image display apparatus provided with an optical unit according to the present invention described above. According to the illustrated example, the optical unit shown in FIG. 1A is installed in the interior of a housing 18 which is formed in a generally box shape using, for example, a plastic or metallic plate. A projection lens 13 of the optical unit is installed in part of a side wall of the housing 18 in such a manner that an image can be projected to the exterior through the projection lens.

Further, in part of the housing 18 are installed a polygon mirror 9, a power supply section 19 for the supply of electric power to the lamp as the light source 1 and for the supply of electric power to drive a rotary fan motor and the like, a control circuit for controlling the quantity of light emitted from the lamp as the light source 1 and for controlling the electric power to be fed to the motor, a video signal processing circuit adapted to receive a signal from the exterior and produce a video signal to be fed to the image display element 11, and a control section 20 which includes, for example, a microprocessor or the like for controlling the entire apparatus including other elements (not shown). In the microprocessor, by synchronizing the drive control for the color light moving means with the video signal transmitted to the image display element, a system which offers a color image can be provided.

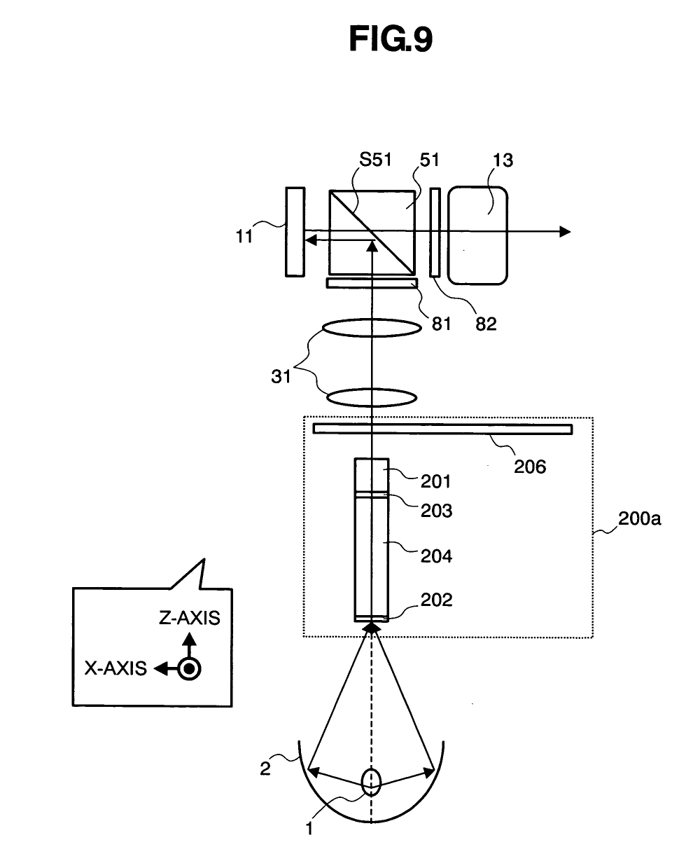

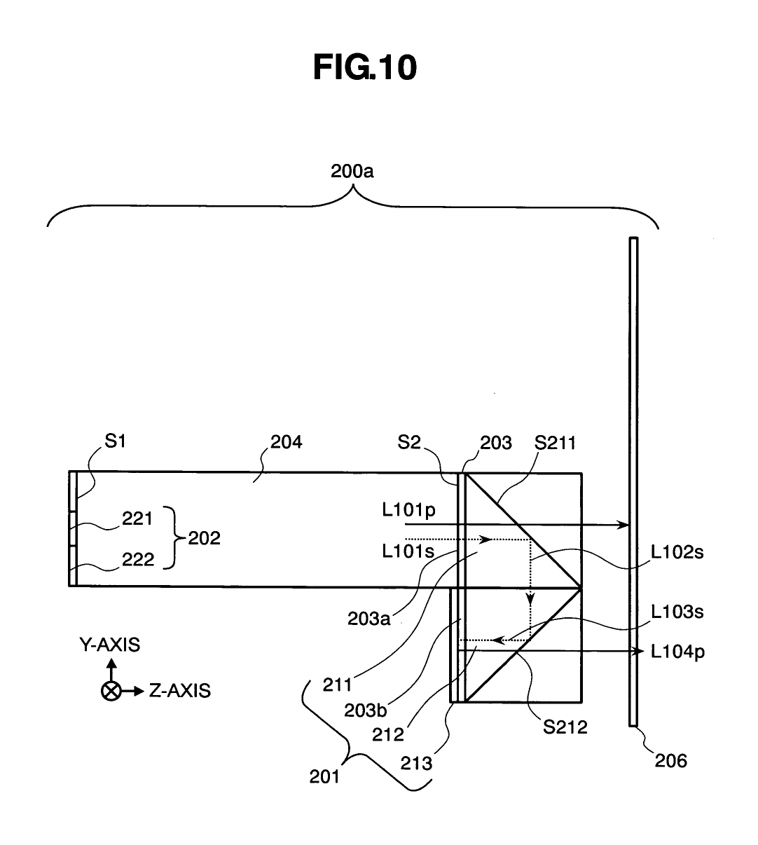

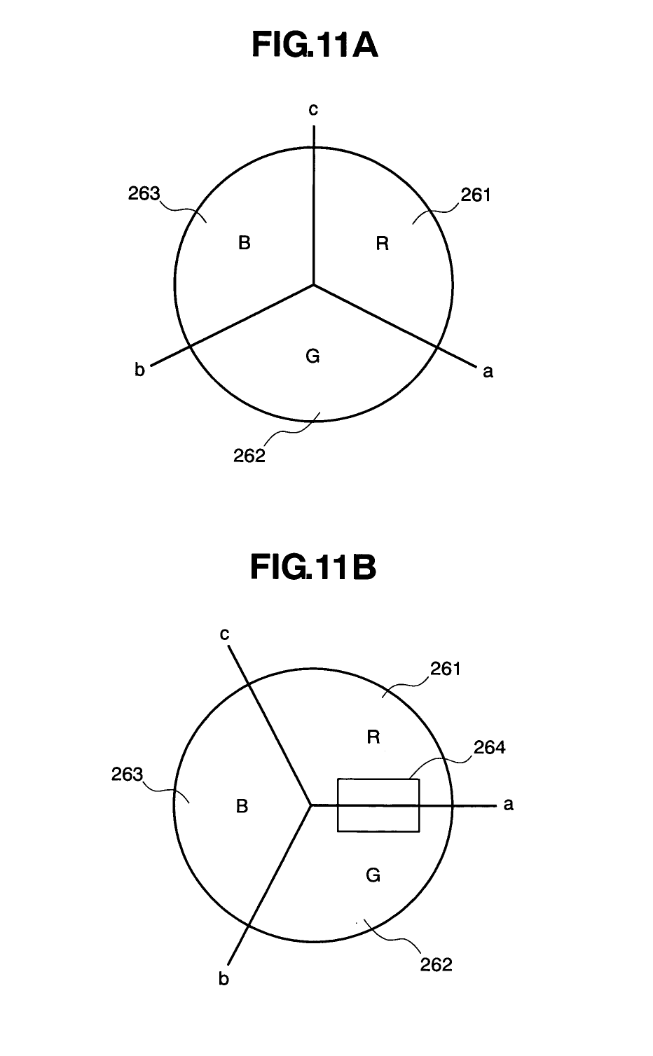

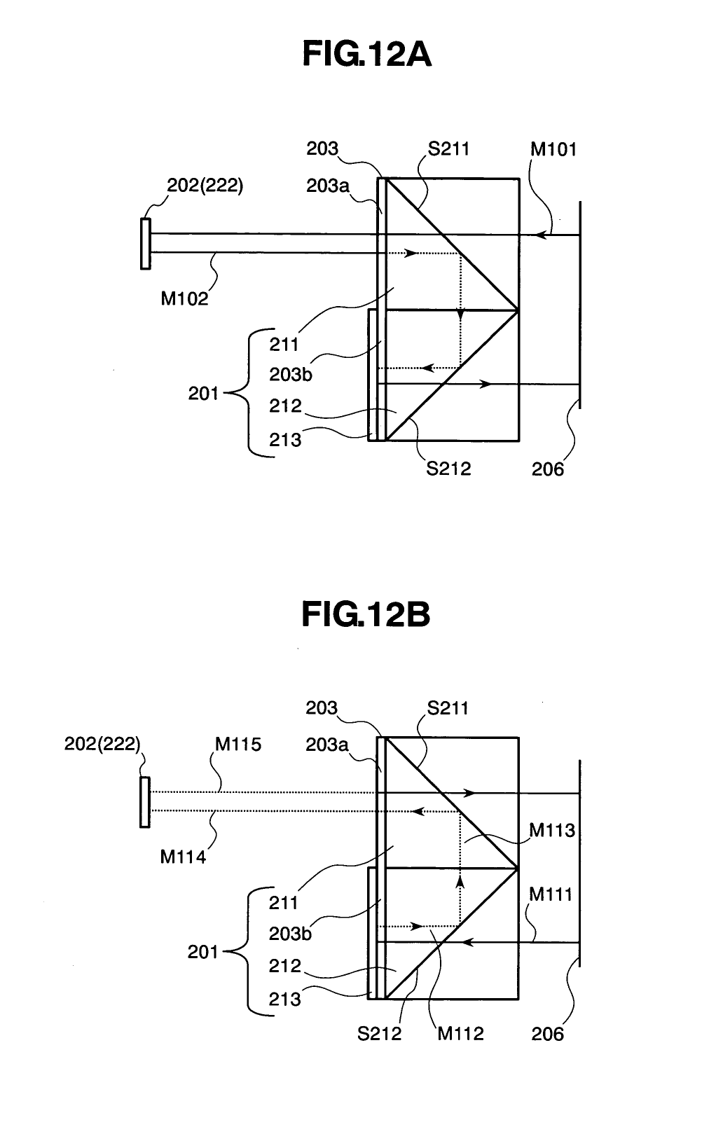

With reference to drawings, a description will be given below about a projection type image display apparatus according to an eighth embodiment of the present invention, as well as a polarization converter/color separator unit used therein. FIG. 9 is a construction diagram of the projection type image display apparatus of the eighth embodiment, FIG. 10 is a construction diagram of a polarization converter/color separator unit as a principal portion of the projection type image display apparatus of the eighth embodiment, FIG. 11 is a construction diagram of a color wheel as a rotary color separator unit, and FIG. 12 is a light-ray diagram illustrating a re-circulation process of a light beam reflected by the color wheel.

The polarization converter/color separator unit indicates an optical system including an optical waveguide for uniforming the light quantity distribution of light emitted from the white light source, polarization converter means for converting the visible light beam rendered uniform by the optical waveguide into a predetermined polarized light, and a rotary color separator unit for separating the visible light beam after conversion to the predetermined polarized light by the polarization converter means into light beams of a plurality of colors. The rotary color separator unit has a mechanism adapted to rotate about an axis perpendicular to a color separation plane. The polarization converter/color separator unit exclusive of the rotary color separator unit will hereinafter be referred to as the polarization converter/separator unit.

First, with reference to FIG. 9, a description will be given about a single plate projection type image display apparatus using the polarization converter/color separator unit relates to this eighth embodiment. In order to facilitate illustration of the drawings which follow, a right-hand rectangular coordinate system is introduced into FIG. 9. That is, it is assumed that the optical axis direction of the light source unit is Z axis, the direction orthogonal to the paper surface of FIG. 9 and advancing from the back side to the surface side of the paper is Y axis, and an axis orthogonal to YZ plane formed by Y and YZ axes is X axis.

In FIG. 9, a light beam of a generally white color is emitted from a light source unit having both a light source 1 and a reflector 2. The light beam is condensed on an incidence-side end face of a polarization converter/color separator unit 200a disposed near a second focal position of the reflector 2, and is incident on the polarization converter/color separator unit 200a.

The polarization converter/color separator unit 200a includes an incidence aperture plate 202, an optical waveguide 204, a quarter-wave plate 203, a polarization converter 201, and a color wheel 206, in order from the incidence side. The details will be described later. The polarization converter/color separator unit 200a has a polarization converting function of converting the polarization direction of the light emitted from the light source unit into a predetermined direction and a color separating function of separating the light into three-color light beams time-dividedly.

The light incident on the polarization converter/color separator unit 200a passes through the same unit. As a result, the polarization of the light is made uniform and the light is separated into R light, G light, and B light, which are then outputted.

The light beam outputted from the polarization converter/color separator unit 200a passes through a mapping optical system 31. The purity of the state of polarization is improved by a polarizing plate 81 which transmits a polarized light in a predetermined direction, then the light beam is applied to a polarization beam splitter 51 which is a polarization separator. The polarization direction of the light beam incident on the polarization beam splitter 51 is assumed to be a direction (s-polarized light) perpendicular to the incidence plane (a plane formed by both incident light ray and reflected light ray; ZX plane). Therefore, the direction of the polarized light which the polarizing plate 81 transmits is assumed to be s-polarized light. The s-polarized light incident on the polarization beam splitter 51 is reflected by a polarization separating surface S51 and enters an image display element 11. The state of polarization of light rays reflected by pixels of the image display element 11 is converted to p-polarized light when the pixels are ON. Thus, the light beam passes through the polarization beam splitter 51 and is projected on a larger scale onto a screen (not shown) by means of a projection lens 13. When the pixels are OFF, the state of polarization is still s-polarized light. Thus, the light beam is again reflected by the polarization plane of the polarization beam splitter 51 and is not projected on a larger scale onto a screen or the like. Numeral 82 denotes a polarizing plate which transmits p-polarized light.

The polarization converter/color separator unit 200a will now be described with reference to FIG. 10. As shown in FIG. 10, the polarization converter/color separator unit 200a is made up of an optical waveguide 204 for uniforming the light quantity distribution, a quarter-wave plate 203, a polarization converter 201 for uniforming the polarization direction of a light beam outputted from the optical waveguide 204 to a predetermined polarization direction, and a color wheel 206 as a rotary color separator unit, in order from the incidence side. In the polarization converter/color separator unit 200a, since the incidence plane (a plane formed by both incident light ray and reflected light ray) of the polarization converter 201 is a YZ plane, light whose polarization direction is perpendicular to the YZ plane is s-polarized light and light whose polarization direction is parallel to the YZ plane is p-polarized light.

A description will be given about the construction of the polarization converter/color separator unit 200a. The optical waveguide 204 has a prismatic structure formed by an optically transparent member (e.g., glass member) of a generally quadrangular section. On the incidence side of the optical waveguide 204, an incident aperture plate 202 having an optical incidence aperture 221 is provided. A total reflection surface 222 is formed around the incidence aperture 221 of the incidence aperture plate 202 and in an inner surface region of the optical waveguide. The incidence aperture 221 is positioned near a second focal position of the reflector 2.

The quarter-wave plate 203 is disposed between the optical waveguide 204 and the polarization converter 201. The function differs between quarter-wave plates 203a and 203b. The quarter-wave plate 203a is disposed between the optical waveguide 204 and the polarization converter 201. The quarter-wave plate 203b is opposed to only the polarization converter 201 (the details thereof will be described later).

The polarization converter 201 includes a first polarization separating prism 211 disposed in Y-axis direction, a second polarization separating prism 212, and a retarder for shifting the phase of light by half a wavelength. In this embodiment, the retarder is composed of the quarter-wave plate 203b disposed on a surface opposed to an exit surface of the second polarization separating prism 212 and a total reflection mirror 213. That is, the quarter-wave plate 203b is adjacent to the surface opposed to the exit surface of the second polarization separating prism 212. The total reflection mirror 213 is adjacent to the surface of the quarter-wave plate 203b, the opposite surface thereof being in contact with the second polarization separating prism 212.

The first polarization separating prism 211 is disposed on the side where a light beam is outputted from the optical waveguide 204. The second polarization separating prism 212 is disposed on -Y side (lower side in FIG. 10) of the first polarization separating prism 211. Polarization separating surfaces S211 and S212 are disposed so as to be orthogonal to each other. The total reflection mirror 213 is disposed on a side face in -Z axis direction of the second polarization separating prism 212 through the quarter-wave plate 203b.

As shown in FIG. 11A, the color wheel 206 disposed on the exit side of the polarization converter 201 is in the form of a thin disc and includes a plurality of color separating regions formed within a plane. Each color separating region transmits light in a predetermined wavelength band included in incident light and reflects light in other wavelength bands included in the incident light to separate the incident light into different colors. The color wheel 206 is positioned centrally of the plane and is adapted to rotate about an axis which is perpendicular to the plane. In the plural color separating regions are arranged a red color light transmitting dichroic mirror 261 which transmits only R light and reflects light beams of other colors, a green color light transmitting dichroic mirror 262 which transmits only G light and reflects light beams of other colors, and a blue color light transmitting dichroic mirror 263 which transmits only B light and reflects light beams of other colors. Line “a” represents a boundary line between the red color light transmitting dichroic mirror 261 and the green color light transmitting dichroic mirror 262. Line “b” represents a boundary line between the green color light transmitting dichroic mirror 262 and the blue color light transmitting dichroic mirror 263. Line “c” represents a boundary line between the green color light transmitting dichroic mirror 262 and the blue color light transmitting dichroic mirror 263.

Referring back to FIG. 10, a description will now be given about the function of the polarization converter/color separator unit 200a. The light as natural light (non-polarized light) of a generally white color emitted from the light source unit and incident on the optical incidence aperture 221 of the incidence aperture plate 202 enters the optical waveguide 204. The incident light is reflected repeatedly by the side face of the optical waveguide 204, whereby the light quantity distribution is made uniform. The light having passed through the optical waveguide 204 then passes through the quarter-wave plate 203a (the function of this portion will be described later), but is still natural light even after passing through the quarter-wave plate. The light having passed through the quarter-wave plate 203a enters the polarization converter 201, whereby the state of polarization thereof is uniformed into a predetermined state of polarization (p-polarized light in the illustrated example). Thus, since the light which has been fully diffused in the optical waveguide 204 enters the polarization converter 201, the rise in temperature of the polarization converter 201 is decreased in comparison with the prior art and there is little loss caused by the rise of temperature.

The polarization converting action of the polarization converter 201 will be described in detail. P-polarized light L101p included in the white light incident on the polarization converter 201 from the optical waveguide 204 passes through the first polarization separating surface S211 and reaches the color wheel 206 disposed on the output side of S211. On the other hand, s-polarized light L101s included in the white light incident on the polarization converter 201 is reflected by the first polarization separating surface S211 and enters (L102s) the second polarization separating prism 212. Then, the s-polarized light L101s is reflected by the second polarization separating surface S212, changes its advancing direction into -Z direction (L103s), and passes through the quarter-wave plate 203b. Then, it is reflected by the total reflection mirror 213, and again passes through the quarter-wave plate 203b, whereby the s-polarized light is converted to p-polarized light (L104p), followed by passing through the second polarization separating surface S212 and reaching the color wheel 206. The polarization converter 201 uniforms the non-polarized incident light into p-polarized light.

The light having reached the color wheel 206 is separated into red R light, green G light, and blue B light time-dividedly by the plural color separating regions. That is, the red color light transmitting dichroic mirror 261 transmits R light and reflects G light and B light. The green color light transmitting dichroic mirror 262 transmits G light and reflects B light and R light. Further, the blue color light transmitting dichroic mirror 263 transmits B light and reflects R light and G light. In this way, the color wheel 206 separates light into R light, G light, and B light, of red, green, and blue colors.

With reference to FIGS. 10, 11, and 12, a re-circulation process of the light reflected by the color wheel 206 will be described. A description will now be given of the case where a spot 264 of light emitted from the polarization converter 201 is positioned between the red color light transmitting dichroic mirror 261 and the green color light transmitting dichroic mirror 262 as shown in FIG. 11B. FIG. 12 schematically illustrates the re-circulation process of the light reflected by the color wheel.

The light beams (G light and B light) included in the light emitted from the polarization converter 201 and other than R light which has reached the red color light transmitting dichroic mirror 261, as well as the light beams (R light and B light) other than G light which has reached the green color light transmitting dichroic mirror 262, are reflected. The reflected light beams are again incident on the polarization separator 201. FIG. 12A illustrates a re-circulation path of light M101 which is included in the light incident on the polarization converter 201 and which has entered the first polarization separating prism 211.

In FIG. 12A, since the light M101 is p-polarized light, it passes through the first polarization separating surface S211 and further through the quarter-wave plate 203a, and changes into circularly polarized light. Then, the light M101 passes through the optical waveguide 204 and reaches the incidence aperture plate 202. The light M101 having reached the total reflection surface 222 of the incidence aperture plate 202 is reflected, passes again through the optical waveguide 204 and further through the quarter-wave plate 203a, then is applied to the polarization converter 201 (M102). At this time, since the circularly polarized light again passes through the quarter-wave plate 203a, it changes into s-polarized light having a linear polarization. Thereafter, the s-polarized light travels along the same path as that of the white s-polarized light which has entered the polarization converter 201 as described above, passes through the second polarization separating surface S212 and is again applied to the color wheel 206.

FIG. 12B illustrates a re-circulation path of light M111 which is included in the light reflected by the color wheel 206 and which has entered the second polarization separating prism 212. Since the light M111 is p-polarized light, it passes through the second polarization separating surface S212 and further through the quarter-wave plate 203b, and changes into circularly polarized light. Then, the light M111 is reflected by the total reflection mirror 213 and again passes through the quarter-wave plate 203b into s-polarized light. The s-polarized light is applied to the second polarization separating prism (M112). The s-polarized light is then reflected by the second polarization separating surface S212 and applied to the first polarization separating prism 211 (M113), then is again reflected by the first polarization separating surface S211.

The reflected light M114 passes through the quarter-wave plate 203a and changes into circularly polarized light. Then, the light M114 passes through the optical waveguide 204 and reaches the incidence aperture plate 202. The light having reached the total reflection surface 222 of the incidence aperture plate 202 is reflected, again passes through the optical waveguide 204 and further through the quarter-wave plate 203a, then is applied to the polarization converter 201 (M115). At this time, since the circularly polarized light again passes through the quarter-wave plate 203a, it changes into p-polarized light having a linear polarization. Thereafter, the p-polarized light travels along the same path as that of the p-polarized light which has entered the polarization converter 201, passes through the first polarization separating surface S211 and again becomes incident on the color wheel 206.

As described above, the light reflected by the color wheel 206 returns to the incidence aperture plate 202, and is reflected by the total reflection surface 222 of the incidence aperture plate 202. Then, the light again becomes incident on the color wheel 206. At this time, since the light passes twice through the quarter-wave plate 203a twice, the state of polarization switches from one to the other between p-polarized light and s-polarized light. The inversion of optical path for p-polarized light and s-polarized light is repeated as described earlier. That is, the light reflected by the color wheel 206 and incident from the first polarization separating prism 211 returns to the incidence aperture plate 202 and is reflected by the total reflection surface 222, then is again outputted from the second polarization separating prism 212. The light reflected by the color wheel 206 and incident from the second polarization separating prism 212 returns to the incidence aperture plate 202 and is reflected by the total reflection surface 222, then is again outputted from the first polarization separating prism 211.

Thus, since the polarizing prisms for re-output invert alternately, the initial incidence point on the color wheel 206 and the re-incidence point on the same wheel do not coincide with each other and there is a possibility that the light may pass through the color wheel 206 while the reciprocation is repeated. That is, it becomes possible to re-utilize (recycle) the light reflected to the light source side and hence the improvement of efficiency is attained.

More specifically, out of G light and B light included in the light spot 264 which has been reflected by the red color light transmitting dichroic mirror 261 of the color wheel 206, the light incident on the first polarization separating prism 211 returns to the incidence aperture plate 202 and is reflected by the total reflection surface 222, then is outputted from the second polarization separating prism 212. In this case, there is a possibility that the G light initially reflected by the red color light transmitting dichroic mirror 261 may become incident on the green color light transmitting dichroic mirror 262 upon re-incidence on the color wheel 206. Likewise, out of R light and B light included in the light spot 264 and reflected by the green color light transmitting dichroic mirror 262, the R light is applied to the second polarization separating prism 212, returns to the incidence aperture plate 202 through the foregoing optical path and is reflected by the total reflection surface 222, then is outputted from the first polarization separating prism 211. In this case, there is a possibility that the R light may become incident on the red color light transmitting dichroic mirror 261 upon re-incidence on the color wheel 206.

It goes without saying that the same effect as above is obtained also in the case where the light spot from the polarization converter 201 straddles the position of the green color light transmitting dichroic mirror 262 and that of the blue color light transmitting dichroic mirror 263 in the color wheel 206 or in the case where the light spot straddles the position of the blue color light transmitting dichroic mirror 263 and that of the red color light transmitting dichroic mirror 261.

In case of recycling of color light reflected in the color wheel, part of the light which has returned to the incidence aperture plate 202 passes to the light source unit side through the incidence aperture 221. However, as noted previously, the polarization converter 201 used in this embodiment is characterized in that it can uniform the incident natural light in a predetermined polarization direction without return to the incidence side. More particularly, consideration is now given to the case where, as the polarization converter to be combined with the polarization converter/color separator unit 200a, for example, a wire grid type reflective polarizing plate is used instead of the combination of the polarizing prism with the quarter-wave plate. In this case, in the process of polarization conversion, part of the light which has returned to the incidence aperture side of the optical waveguide passes to the light source unit through the incidence aperture 221, resulting in a lowering of the polarization conversion efficiency. The polarization converter used in the present invention can improve the efficiency by combining the polarizing prism with the quarter-wave plate.

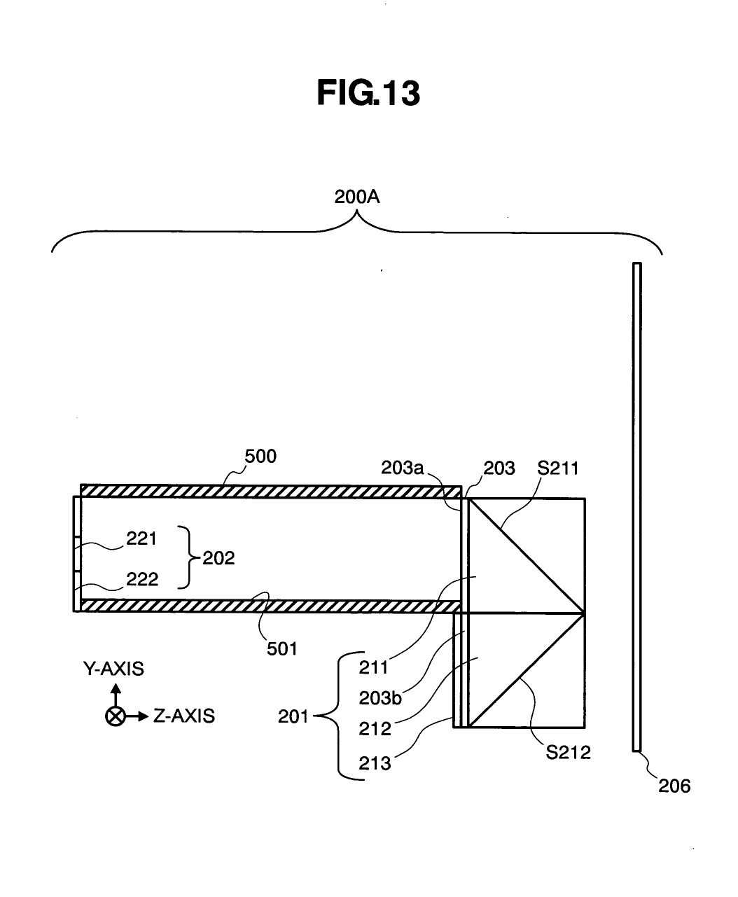

The structure of the optical waveguide 204 is not limited to the above structure of which the interior is all constituted by a transparent member. It may be a hollow structure with a reflecting mirror formed on an inner surface of the optical waveguide 204. FIG. 13 illustrates a polarization converter/color separator unit 200A having an optical waveguide constituted by a mirror. A reflecting mirror 501 is disposed on an inner surface of an optical waveguide 500. Light incident on the optical waveguide 500 travels through the interior of the optical waveguide 500 while being totally reflected repeatedly by the reflecting mirror 501 to make the light quantity distribution uniform. It goes without saying that other operations are the same as above.

Although in the above embodiment the optical waveguide is of a straight type wherein the area of the incidence-side end face and that of the exit-side end face are the same, no limitation is made thereto. The optical waveguide of the straight type does not have an F value converting function and therefore stores the angle of light ray incident on the optical waveguide. That is, since a light ray of a large light ray angle condensed by an ellipsoidal reflector is incident on the optical waveguide, the polarization conversion efficiency in the polarization converter is deteriorated. To remedy this drawback, it is preferable to adopt a construction wherein the area of the incidence-side end face is smaller that that of the exit-side end face, thereby providing an F value converting function to make the angle of light ray at the exit-side end face small.

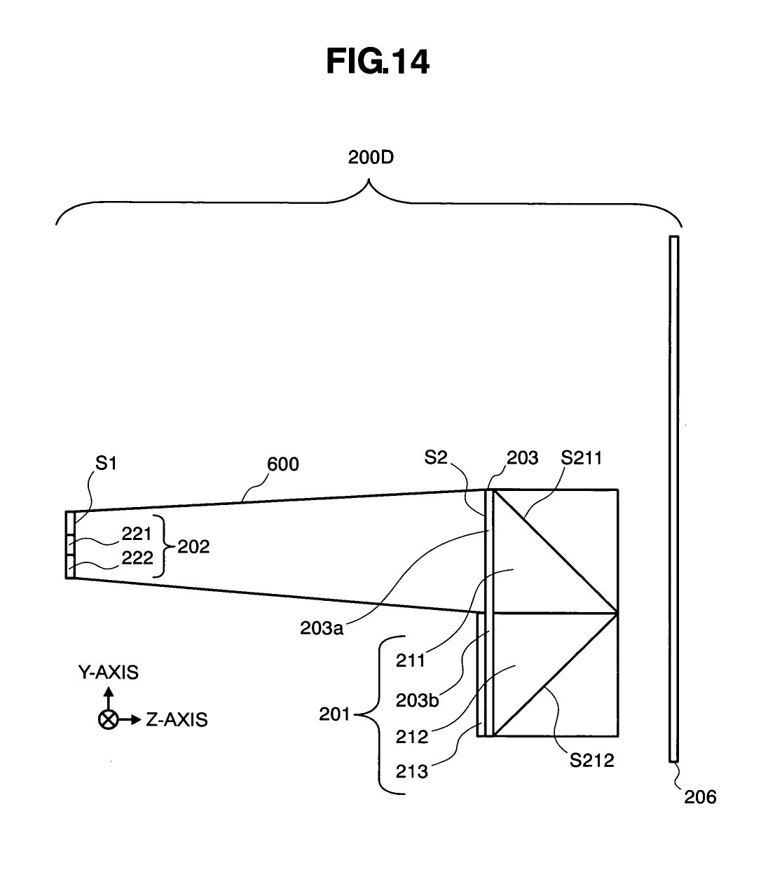

FIG. 14 shows a prismatic optical waveguide 600 wherein the area of an incidence-side end face S1 is smaller than that of an exit-side end face S2. In FIG. 14, the reference mark 2D denotes a polarization converter/color separator unit. In the same way as above, the light quantity distribution is made uniform by the optical waveguide 600, polarization is made uniform into p-polarized light by the polarization converter 201, and color separation is performed by the color wheel 206. Since the optical waveguide 600 is in a prismatic shape wherein the area of the incidence-side end face S1 is smaller than that of the exit-side end face S2, the light incident; from the incidence-side end face S1 is reflected repeatedly, whereby the light ray angle becomes small and in his state the light is outputted from the exit-side end face S2. As a result, the polarization conversion efficiency of the polarization converter 201 can be improved. The light ray angle of the light incident on the color wheel 206 can also be made small. Thus, not only is the color separating performance of the color wheel 206 improved, but also the polarization conversion characteristics in a PBS and the image display element which are disposed in rear positions are improved, resulting in obtaining a high contrast.

As described above, by using the polarization converter/color separator unit according to this embodiment, the utilization efficiency of light is improved and it is possible to provide a projection type image display apparatus with a high luminance.

Although the color wheel described above as color separating means is divided into multiple color separating regions and makes color separation time-dividedly, no limitation is made thereto. For example, a color wheel having a plurality of spirally divided color separating regions toward the center of rotation is also preferable in this embodiment.

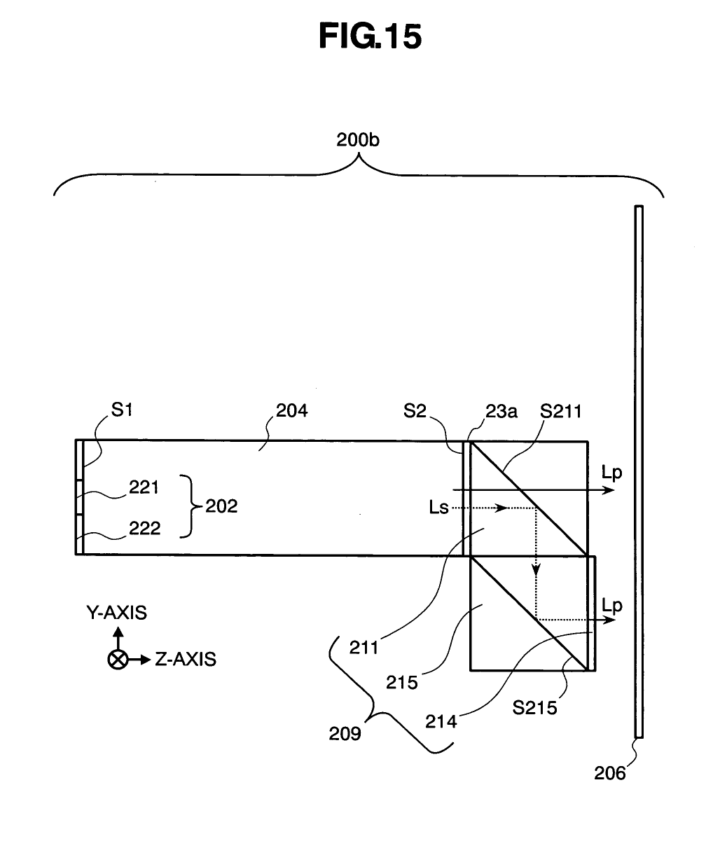

Next, a polarization converter/color separator unit used in a projection type image display apparatus according to a ninth embodiment of the present invention will be described below with reference to FIGS. 11 and 15. FIG. 15 is a construction diagram of the polarization converter/color separator unit which is a principal portion of the projection type image display apparatus.

The polarization converter/color separator unit according to this ninth embodiment corresponds to a modification of the polarization converter/color separator unit used in the projection type image display element of the eighth embodiment. More specifically, the polarization converter provided on the exit side of the optical waveguide is changed from the substantially perpendicular type of the polarization separating surface into a parallel type thereof. The projection type image display apparatus of this embodiment is the same as that of FIG. 9 and therefore an explanation thereof will here be omitted.

A polarization converter/color separator 200b will be described in detail with reference to FIG. 15. As shown in the same figure, the polarization converter/color separator unit 200b is made up of, in order from the incidence side, an optical waveguide 204 having an incidence aperture plate 202, a quarter-wave plate 203a, a polarization converter 209 for making the polarization direction of light from the optical waveguide 204 uniform in a predetermined polarization direction, and a color wheel 206 as a rotary color separator unit.

Light as substantially white natural light introduced from the light source unit incident on an optical incidence aperture 221 formed in the incidence aperture plate 202 becomes incident on the optical waveguide 204. The light quantity distribution of the incident light is made uniform by the optical waveguide 204. Light which has passed through the optical waveguide 204 further passes through the quarter-wave plate 203a. However, since the light is natural light, it is still natural light even after passing through the quarter-wave plate 203a. The light having passed through the quarter-wave plate 203a enters the polarization converter 209, in which the state of polarization thereof is made uniform into a predetermined state of polarization (p-polarized light in the illustrated example). Thus, the light fully diffused in the optical waveguide 204 is incident on the polarization converter 209, so that the rise in temperature of the polarization converter 209 is suppressed in comparison with the prior art and thus there is little loss caused by the rise of temperature.

The polarization converter 209 includes a first polarization separating prism 211 disposed in Y axis direction, a second polarization separating prism 215, and a retarder for shifting the polarization of light by half a wavelength. In this embodiment, the retarder is constituted by a half-wave plate 214 disposed on an exit surface of the second polarization separating prism 215. The first polarization separating prism 211 is disposed on the side where light is outputted from the optical waveguide 204, while the second polarization separating prism 215 is disposed on -Y side (lower side in FIG. 15) of the first polarization separating prism 211. Polarization separating surfaces S211 and S215 are disposed so as to be parallel to each other. The half-wave plate 214 is disposed in contact with the exit-side end face of the second polarization separating prism 215.

The polarization conversion function of the polarization converter 209 will now be described in detail. P-polarized light Lp included in the white light incident on the polarization converter 209 from the optical waveguide 204 passes through the first polarization separating surface S211 and reaches the color wheel 206 disposed on the exit side of the surface S211. On the other hand, s-polarized light Ls included in the white light incident on the polarization converter 209 is reflected by the first polarization separating surface S211 and is further reflected by the second polarization separating surface S215. Then, s-polarized light Ls passes through the half-wave plate 214 and is converted to p-polarized light, then reaches the color wheel 206. The light having reached to the color wheel 206 is separated into R light, G light, and B light. In this embodiment, the second polarization separating surface S215 of the second polarization separating prism 215 is for reflecting s-polarized light and may be a total reflection surface, not a polarization separating surface.

Next, with reference to FIG. 11B and FIG. 15, the following description is provided about a re-circulation process of light reflected by the color wheel 206. A description will be given of the case where a light spot 264 outputted from the polarization converter 209 is positioned between the red color light transmitting dichroic mirror 261 and the green color light transmitting dichroic mirror 262, as in the previous eighth embodiment.

With respect to the light outputted from the polarization converter 209, light beams (G light and B light) other than R light having reached the red color light transmitting dichroic mirror 261 in the color wheel 206 and light beams (R light B light) other than G light having reached the green color light transmitting color wheel 262 in the color wheel are reflected. The reflected light beams are again incident on the polarization converter 209.

Since light included in the polarization converter 209 and directed to the first polarization separating prism 211 is p-polarized light, the light passes through the first polarization separating surface S211 and through the quarter-wave plate 203a, further through the optical waveguide 204, and reaches the incidence aperture plate 202. The light which has reached a total reflecting surface 222 of the incidence aperture plate 202 is reflected, again passes through the optical waveguide 204, further passes through the quarter-wave plate 203a, and becomes incident on the polarization converter 209. At this time, since the light passes twice reciprocatively through the quarter-wave plate 203a, the light which is p-polarized light changes into s-polarized light, then travels along the same path as that of the s-polarized light incident on the polarization converter 209, and again becomes incident on the color wheel 206.

With respect to the light reflected by the color wheel 206, the light incident on the second polarization separating prism 215 passes through the half-wave plate 214. Then, after conversion from p-polarized light to s-polarized light, the light is reflected by the second polarization separating surface S215, further reflected by the first polarization separating surface S211, then passes through the quarter-wave plate 203a, further passes through the optical waveguide 204, and reaches the incidence aperture plate 202. The light which has reached the total reflection surface 222 of the incidence aperture plate 202 is reflected, again passes through the optical waveguide 204, further through the quarter-wave plate 203a, and becomes incident on the polarization converter 209. At this time, since the light passes twice reciprocatively through the quarter-wave plate 203a, the light which is s-polarized light is converted to p-polarized light, then is incident on the first polarization separating prism 211, passes through the first polarization separating surface S211, and again becomes incident on the color wheel 206.

That is, the light reflected by the color wheel 206 and incident from the first polarization separating prism 211 returns to the incidence aperture plate 202, then is reflected by the total reflection surface 222, and is again outputted from the second polarization separating prism 215. The light reflected by the color wheel 206 and incident from the second polarization separating prism 215 returns to the incidence aperture plate 202, then is reflected by the total reflection surface 222, and is again outputted from the first polarization separating prism 211.

Since the positions of polarization separating prisms as light re-output prisms are thus inverted alternately, an initial incident point on the color wheel 206 and a repeated incident point on the same color wheel do not coincide with each other, and there is a possibility that the light may pass through the color wheel 206 during repeated reciprocation. That is, it becomes possible to re-utilize (recycle) the color light reflected to the light source side and hence the efficiency is improved.

More specifically, with respect to the light spot 264 in the color wheel 206, G light incident on the first polarization separating prism 211, out of G light and B light reflected by the portion of the red color light transmitting dichroic mirror 261, returns to the incidence aperture plate 202, then is reflected by the total reflection surface 222 and is outputted from the second polarization separating prism 215. There is a possibility that the G light initially reflected by the red color light transmitting dichroic mirror 261 may become incident on the portion of the green color light transmitting dichroic mirror 262 in the light spot 264 upon re-incidence on the color wheel 206. Likewise, with respect to the light spot 264, out of R light and B light reflected by the portion of the green color light transmitting dichroic mirror 262, R light is incident on the second polarization separating prism 215, passes through the foregoing optical path, again returns to the incidence aperture plate 202 and is reflected by the total reflection surface 222, then is outputted from the first polarization separating prism 211. This light may become incident on the portion of the red color light transmitting dichroic mirror 261 upon re-incidence on the color wheel 206.

It goes without saying that the same effect as above can be obtained also in the case where the light spot outputted from the polarization converter 209 straddles the position of the green color light transmitting dichroic mirror 262 in the color wheel 206 and that of the blue color light transmitting dichroic mirror 263 in the color wheel or in the case where the light spot in question straddles the position of the blue color light transmitting dichroic mirror 263 and that of the red color light transmitting dichroic mirror 261.

In case of recycling reflected color light in the color wheel, part of the light which has returned to the incidence aperture plate 202 passes to the light source unit side through the incidence aperture 221. However, as noted earlier, the polarization converter 209 used in this embodiment is characterized in that it can uniform the incident natural light in a predetermined polarization direction without return to the incidence side. In the case where the combination of the two polarizing prisms and the half-wave plate in this embodiment is substituted, for example, by a wire grid type reflective polarizing plate as the polarization converter used in the polarization converter/color separator unit 200b, it becomes possible to improve the polarization conversion efficiency as in the eighth embodiment. In this case, the optical waveguide 204 may use the construction of FIG. 13 or FIG. 14 referred to above in the eighth embodiment.

As described above, according to the polarization converter/color separator unit in this embodiment, the utilization efficiency of light is improved and it is possible to provide a projection type image display element with a high luminance.

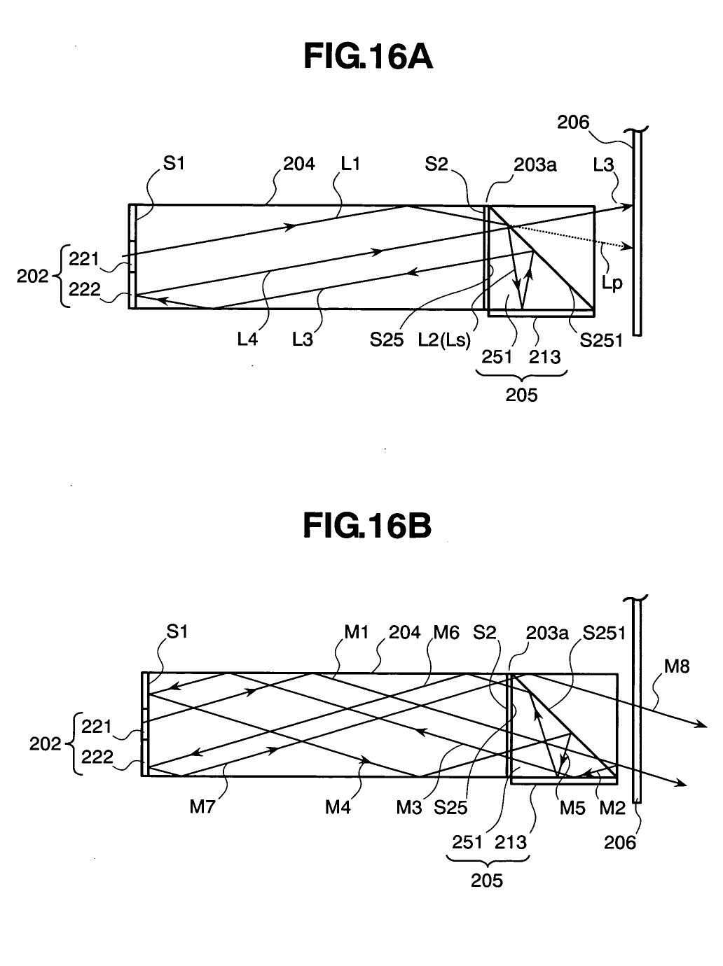

With reference to FIGS. 11 and 16, a description will be given below about a polarization converter/color separator unit used in a projection type image display apparatus according to a tenth embodiment of the present invention. FIG. 16 shows a construction diagram of the polarization converter/color separator unit in the apparatus in the tenth embodiment and a light ray diagram added thereto for explaining the operation of the same unit.

The polarization converter/color separator unit in this tenth embodiment corresponds to a modification of the polarization converter/color separator unit in the apparatus in the eighth embodiment. More specifically, the polarization converter disposed on the exit side of the optical waveguide in the polarization converter/color separator unit in the eighth embodiment's apparatus is substituted by a construction comprising one polarization separating prism and a total reflection mirror. The projection type image display apparatus of this embodiment is the same as the FIG. 9 apparatus and therefore an explanation thereof will be omitted. In FIG. 16, elements having the same functions as in FIG. 10 are identified by the same reference numerals as in FIG. 10, and duplicated explanations thereof will be omitted.

The polarization converter/color separator unit 200c will now be described in detail with reference to FIG. 16. As shown in the same figure, the polarization converter/color separator unit 200c is made up of, in order from the incidence side, an optical waveguide 204 having an incidence aperture plate 202, a quarter-wave plate 203a, a polarization converter 205 disposed in contact with the quarter-wave plate 203a to make the polarization direction of light from the optical waveguide 204 uniform in a predetermined polarization direction, and a color wheel 206 as a rotary color separator unit.

The light as substantially white natural light incident from the light source unit on the optical incidence aperture 221 of the incidence aperture plate 202 enters the optical waveguide 204. The light quantity distribution of the incident-light is made uniform by the optical waveguide 204. The light which has passed through the optical waveguide 204 further passes through the quarter-wave plate 203a, but is still natural light even thereafter. The light after passing through the quarter-wave plate 203a becomes incident on the polarization converter 205 and its polarization state is made uniform into a predetermined polarization state (p-polarized light in the illustrated example). Thus, since light fully diffused in the optical waveguide 204 is incident on the polarization converter 205, the rise in temperature of the polarization converter 209 is suppressed in comparison with the prior art and there is little loss caused by the rise of temperature.

The polarization converter 205 includes a polarization separating prism 251 which is disposed on the exit side of the rod integrator 24 through the quarter-wave plate 203a and a total reflection mirror 213 which is provided on a side face of the polarization separating prism 251 to which predetermined polarized light reflected by a polarization separating surface S251 of the prism 251 is directed.

The polarization converting action of the polarization converter 205 will now be described in detail with reference to FIG. 16A. FIG. 16A is a light-ray diagram illustrating the polarization converting action of the polarization converter 205. The polarization converter 205 used in this embodiment is different from the polarization converters described in the eighth and ninth embodiments. The polarized light reflected by the polarization separating prism 251 returns to the optical waveguide 204, then is reflected by a total reflection surface 222 and again becomes incident on the polarization converter 205. Thus, it performs re-circulation. In the course of this re-circulation, the light passes twice through quarter-wave plate 203a, whereby s-polarized light is converted to p-polarized light.

In FIG. 16A, p-polarized light Lp included in white light L1 incident on the polarization converter 205 from the optical waveguide 204 passes through the polarization separating surface S251 and reaches the color wheel 206 disposed on the exit side of the surface S251. On the other hand, s-polarized light Ls included in the white light L1 incident on the polarization converter 205 is reflected by the polarization separating surface S251. The reflected s-polarized light (light L2) is further reflected y the total reflection mirror 213, then is reflected again by the polarization separating surface S251 and advances from the incidence-side end face S25 of the polarization converter 205 toward the optical waveguide 204 (light L3). The light L3 passes through the quarter-wave plate 203a into circularly polarized light, which then enters the optical waveguide 204 and reaches the incidence aperture plate 202 while being reflected repeatedly in the interior of the optical waveguide. The light having reached the total reflection surface 222 of the incidence aperture plate 202 is reflected (light L4), travels toward the exit-side end face S2 of the optical waveguide 204 and passes through the quarter-wave plate 203a. During this transmission, the circularly polarized light changes into p-polarized light having a linear polarization, which is then incident on the polarization converter 205. Because of p-polarized light, the light passes through the polarization separating surface S251 and is again incident on the color wheel 206.

Thus, while the light re-circulates along the optical path between the total reflection surface 222 and the total reflection mirror 213, the polarization direction changes and the light passes through the polarization separating surface S251, whereby the p-polarized light in a specific polarization direction can be obtained in a successive manner. That is, it is possible to perform polarization conversion.

Part of the s-polarized light which has returned to the incidence aperture plate 202 passes to the light source unit side through the incidence aperture 221. Consequently, the polarization converter used in this embodiment decreases in its efficiency as compared with the polarization converts described in the eighth and ninth embodiments. However, since a single polarization separating prism is sufficient, it is possible to reduce the cost and it is advantageous to reduce the size.

With reference to FIGS. 11B and 16B, a description will be given about a re-circulation process of the light reflected by the color wheel 206. FIG. 16B is a light ray diagram illustrating a re-circulation process of the light reflected by the color wheel 206. The following description is provided about the case where a light spot 264 outputted from the polarization converter 205 is positioned between the red color light transmitting dichroic mirror 261 and the green color light transmitting dichroic mirror 262 as in the eighth embodiment.

Here, a concrete description will be given below while paying attention to R light reflected by the portion of the green color light transmitting dichroic mirror 262 in the light spot 264.

Light which has entered the interior of the optical waveguide 204 from the incidence aperture 221 travels toward the exit-side end face S2 while repeating reflection within the optical waveguide 204, then passes through the quarter-wave plate 203a and becomes incident on the polarization converter 205. P-polarized light M1 which has passed through the polarization separating surface S251 becomes incident on the color wheel 206 to form a light spot 264. Out of R light and Blight reflected by the portion of the green color light transmitting dichroic mirror 262 in the light sport 264 of the color wheel 206, light M2 which has entered the polarization converter 205 is p-polarized light. Thus, the light M2 passes through the polarization separating surface S25, then is reflected by the total reflection mirror 213 and advances to the optical waveguide 204 from the incidence-side end face S25 of the polarization converter 205 (light M3). The light M3 passes through the quarter-wave plate 203a and changes into circularly polarized light, which then enters the optical waveguide 204 and reaches the incidence aperture plate 202 while repeating reflection in the interior of the optical waveguide. Light having reached the total reflection surface 222 of the incidence aperture plate 202 is reflected (light M4), travels toward the exit-side end face S2 while repeating reflection again in the interior of the optical waveguide 204, and passes through the quarter-wave plate 203a. During this transmission, the circularly polarized light changes into s-polarized light having a linear polarization, which is applied to the polarization converter 205.

The light M4 as s-polarized light is reflected by the polarization separating surface S251. The reflected s-polarized light, which is indicated by M5, is reflected by the total reflection mirror 213, then is reflected again by the polarization separating surface S251, and advances toward the optical waveguide 204 from the incidence-side end face S25 of the polarization converter 205 (light M6). The light M6 passes through the quarter-wave plate 203a and changes into circularly polarized light, which then enters the optical waveguide 204 and reaches the incidence aperture plate 202 while repeating reflection in the interior of the optical waveguide. The light which has reached the total reflection surface 222 of the incidence aperture plate 202 is again reflected and advances toward the exit-side end face S2 while repeating reflection in the interior of the optical waveguide 204 (light M7). The light M7 passes through the quarter-wave plate 203a, whereby the circularly polarized light changes into p-polarized light having a linear polarization, which is then applied to the polarization converter 205. Since the light is p-polarized light, it passes through the polarization converter 205. At this time, the light is totally reflected by a side face of the polarization separating prism 251 and is again incident on the color wheel 206 (light M8).

In this way, there is a possibility that the R light reflected by the portion of the green color light transmitting dichroic mirror 262 in the light spot 264 may re-circulate and become incident on the portion of the red color light transmitting dichroic mirror 261 in the light spot 264.

Likewise, although the details are omitted, there is a possibility that the G light reflected by the portion of the red color light transmitting dichroic mirror 261 in the light spot 264 may re-circulate and become incident on the portion of the green color light transmitting dichroic mirror 262 in the light spot 264.

That is, it becomes possible to re-utilize (recycle) the color light reflected to the light source side and thus the efficiency is improved.

As described above, since the point of initial incidence on the color wheel 206 is different from the point of re-incidence on the color wheel 206, there is a high possibility that the re-circulated (returned) light passes through the color wheel 206. It goes without saying that the same effect can be obtained also in the case where the spot of light outputted from the polarization converter 205 straddles the position of the green color light transmitting dichroic mirror 262 and that of the blue color light transmitting dichroic mirror 263 in the color wheel 206 or in the case where the light spot straddles the position of the blue color light transmitting dichroic mirror 263 and that of the red color light transmitting dichroic mirror 261. In this case, the optical waveguide 204 may use the construction as shown in FIG. 13 or FIG. 14 referred to previously in the eighth embodiment.

Thus, by using the polarization converter/color separator unit according to this embodiment, the utilization efficiency of light is improved and it is possible to provide a projection type image display apparatus with a high luminance.

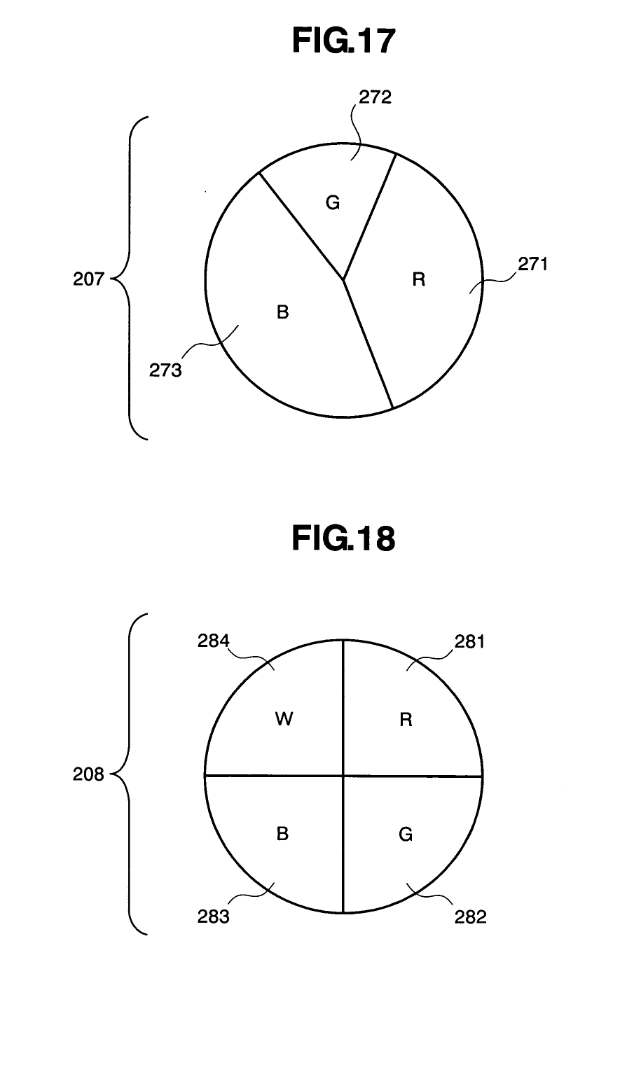

Although, in the color wheel 206 described in the above embodiments, the areas of the red, green and blue color light transmitting dichroic mirrors 261, 262, 263 are almost the same, a construction may be adopted in which the area of at least one color light transmitting dichroic mirror is different from the others. FIG. 17 shows a constructional example of a color wheel 207 having color light transmitting regions having different areas. In the same figure, a red color light transmitting dichroic mirror 271, a green color light transmitting dichroic mirror 272, and a blue color light transmitting dichroic mirror 273 are regions for transmitting R light, G light, and B light, respectively, which are of specific wavelength regions. As shown in FIG. 17, the area of at least one of those dichroic mirrors 271, 272, and 273 is made different from the others, whereby it becomes possible to make adjustment of the brightness and color.

FIG. 18 shows a constructional example of a color wheel 208 provided with a white color transmitting dichroic mirror 284. In the same figure, a red color light transmitting dichroic mirror 281, a green color light transmitting dichroic mirror 282, a blue color light transmitting dichroic mirror 283, and a white color light transmitting dichroic mirror 284, are regions for transmitting R light, G light, B light, and W light, respectively, which are of specific wavelength regions. With the white color light having passed through the white color light transmitting dichroic mirror 284, a bright projection image can be obtained.

In the above description, the number of colors to be separated is three which are R, G, and B. However, the combination of Y (yellow), C (cyan), and M (magenta), may be adopted. Even a combination of three or more colors, e.g., a combination of R, G, B, and Y, may be adopted. In the case where plural colors of three or more are used, since the number of colors increases, the chromaticity indication range so far expressed in a triangular shape in the case of three colors can be replaced with a quadrangular range, resulting in an effect that the chromaticity indication range becomes wider. The layout of dichroic mirror regions is not limited to the illustrated one.

What is claimed is:

1. A projection type image display apparatus comprising:
a light source;
an optical waveguide to which light emitted from said light source is radiated;
a polarization converter for making the light emitted from said light source uniform in a predetermined direction;
a color separator having a plurality of filters for separating the light emitted from said light source into desired color light beams;
an image display element for forming an optical image with use of plural color light beams separated by said color separator; and
a reflecting member for reflecting light included in the light from said light source and reflected by said color separator.

2. A projection type image display apparatus comprising:
a light source;
an integrator for making light emitted from said light source uniform, said integrator comprising a first optical waveguide into which the light emitted from said light source is introduced, a polarization converter for making the light from said first optical waveguide uniform in a specific polarization direction, a second optical waveguide having an incidence surface into which the light outputted from said polarization converter is introduced, and a reflecting mirror disposed on at least a part of the inside of said incidence surface;
a color separator for separating light emitted from said integrator into a plurality of color light beams;
a liquid crystal display element for forming an optical image corresponding to a video signal with use of the plural color light beams;
a projection lens for projecting said optical image;
a power supply for supplying electric power to said light source; and
an image signal processing circuit for supplying said video signal to said liquid crystal display element.

3. A projection type image display apparatus according to claim 2, wherein, in said first optical waveguide, the area of an exit-side side face is larger than that of an incidence-side side face.

4. A projection type image display apparatus according to claim 3, wherein an aperture is formed in said incidence surface and said reflecting mirror is disposed on at least a part of an outer periphery of said aperture.

5. A projection type image display apparatus according to claim 4, wherein a plurality of said reflecting mirrors are disposed symmetrically with respect to an optical axis of said second optical waveguide.

6. A projection type image display apparatus according to claim 2, wherein, in said second optical waveguide, the area of an exit-side side face is larger than that of said incidence surface.

7. A projection type image display apparatus according to claim 2, wherein said integrator further includes a second incidence surface and a first exit surface, the area of said first exit surface being larger than that of said second incidence surface.

8. A projection type image display apparatus according to claim 2, wherein the number of said liquid crystal element is one.

9. A projection type image display apparatus comprising:
a light source; and
a polarization converter unit for making light emitted from said light source uniform into predetermined polarized light, said polarization converter unit comprising:
an incidence aperture plate having an aperture for receiving light emitted from said light source as a white color light source and a reflecting surface formed as an inner surface in the region other than said aperture;
a rod integrator;
a first polarization separating prism for transmitting light traveling in a first polarization direction and included in light emitted from said rod integrator and allowing the light to be outputted from a first side face, said first polarization separating prism having a first polarization separating surface adapted to reflect light traveling in a second polarization direction toward a second side face;
a quarter-wave plate disposed between said rod integrator and said first polarization separating prism to shift the phase of passing light by half wavelength;
a second polarization separating prism adjacent to said second side face of said first polarization separating prism and having a second polarization separating surface for reflecting the light reflected by said first polarization separating prism and traveling in said second polarization direction toward a third side face direction;
a polarization converter unit disposed on said third side face and having a retarder for shifting the phase of the light reflected in said third side face direction and traveling in said second polarization direction by half wavelength;
a rotary color separator unit having a plurality of color separating surfaces for separating predetermined color light beams from light beams emitted from said first side face and said fourth side face, said rotary color separator unit further having a mechanism adapted to rotate about an axis perpendicular to said color separating surfaces;
an image display element which forms an optical image with use of plural color light beams separated by said rotary color separator unit and wherein color light beams formed on a light-projected surface are scrolled with rotation of said rotary color separator unit;
a mapping optical system for mapping the color light beams separated by said color separating surfaces onto said image display element; and
a projection lens for projecting light emitted from said image display element as a color image.

10. A projection type image display apparatus according to claim 9, wherein said first and second polarization separating surfaces are disposed perpendicularly to each other, and said retarder includes a second quarter-wave plate adjacent to said third side face and a total reflection plate adjacent to a surface of said second quarter-wave plate, the opposite surface thereof being in contact with said second polarization separating prism.

11. A projection type image display apparatus according to claim 10, wherein said second polarization separating prism includes a fourth side face opposed to said third side face to output light which has passed through said second polarization separating surface.

12. A projection type image display apparatus according to claim 10, wherein said first and second polarization separating surfaces are disposed in parallel with each other, and said retarder is a half-wave plate adjacent to said third side face.
